(19) United States
(12) Patent Application Publication
(10) Pub. No.: US 2008/0279996 A1
(43) Pub. Date: Nov. 13, 2008

(54) Method of reducing pathogens during processing or post-processing of beef and other non-poultry meats

(76) Inventors: Gary L. Nace, Claude, TX (US); Terry L. McAninch, Westminster, CO (US)

Correspondence Address: Thomas H. Young, 5500 Hawthorn Cir., Greenwood Village, CO, 80121, US

(21) Appl. No.: 12/151,821

(22) Filed: May 9, 2008

Related U.S. Application Data
(60) Provisional application No. 60/928,941, filed on May 11, 2007.
(60) Provisional application No. 61/070,453, filed on Mar. 22, 2008.

(51) Int. Cl. B65D 81/28; A23B 4/18

(52) U.S. Cl. 426/326; 426/332

(57) ABSTRACT

A method for reducing the incidence of salmonella and/or e-coli and other pathogens in slaughtered beef or other non-poultry meat during processing or post-processing by treating the meat with an effective antimicrobial solution comprising citric and lactic acids.

This application claims the benefit of U.S. provisional patent applications Ser. No. 60/928,941, filed on May 11, 2007, and Ser. No. 61/070,453 filed on Mar. 22, 2008, which are incorporated by reference herein.

### I. FIELD OF THE INVENTION

The present invention relates to an improved method for processing beef or other non-poultry meat products in a manner that substantially reduces or eliminates salmonella, e-coli and other pathogens in the resulting meat products without affecting desirable characteristics of those products, such as their appearance, taste or aroma.

### II. BACKGROUND OF THE INVENTION

Food safety is an important issue in the food industry in general and particularly in the industry of supplying protein, i.e., edible meat products, from animals. By the very nature of the animals, the conditions in which they are grown to suitable size, and the nature of the commercial slaughtering process, “meat packers” face serious challenges in producing products that pass government and industry standards and are safe for consumption. When a problem arises in the slaughtering process, the consequences can be serious in terms of public heath exposing many individuals to serious health consequences, including possibly death. As evidenced by the recent massive recall of approximately 143 million pounds of beef, the economic consequences to the meat packer, retailers and all those in the intermediate distribution chain can also be enormous.

Even after meat products leave the packing plant, they are subject to additional sources of contamination as they are “post-processed,” i.e., cut, tenderized, marinated, cooked and/or packaged into products desired by consumers. The nature and extent of this “post-processing,” has expanded considerably during the past decade as consumers with little time and refined palates have increasingly demanded that the meat supply chain deliver “ready-to-eat” products that are easily prepared into tender, tasteful meals. Each of these processing steps exposes the meat to further sources of contamination until the processed product is wrapped and isolated or served and consumed.

As used herein, “post-processing” refers to any step in processing meat after it leaves the packing plant. This includes a wide range of activities that may occur in the distribution process including wholesale (e.g., processing prior to delivery to a grocery store or restaurant), retail (e.g., processing at a grocery store, meat market, or restaurant) and even by a consumer. (e.g., processing prior to consumption). Risks of meat contamination are particularly high in post-processing events in which the meat contacts another surface, e.g., a cutting instrument—such as a knife or a mechanical tenderizer, such as a device with multiple elongated spikes or needles that are forced into the meat to break up the animal tissue, especially the muscle. “Needling” is used in the commercial processing of meat at wholesale and retail and is frequently used by consumers themselves to tenderize meat.

The problems of post-processing contamination have attracted government scrutiny. Indeed, indications are that a new regulatory protocol will soon be promulgated that would require that any commercial establishment (e.g., grocery store or restaurant) processing meat must employ an antimicrobial spray or treatment prior to any “cutting” of uncooked meat. Among other things, such a regulation, if implemented, would require an antimicrobial intervention prior to any “needling” of meat. Currently, most “processing aids” such as this must result in a minimum of 1 log order reduction in the presence of target microbes. This patent application is directed to compositions and methods that can be employed in the slaughtering and processing operations of a meat packing plant or in post-processing. The compositions and methods described herein have industrial (e.g., meat packing plant), commercial (e.g., grocery store or restaurant) and consumer applications.

Many of the heath issues in the meat industry involve the transmission and growth of microbial pathogens, e.g., e-coli, salmonella and other pathogens that can cause sickness and death when ingested in humans. Indeed, Salmonella and another pathogen known as “Campylobacter” are the two leading bacterial causes of food poisoning in the United States. According to the Center for Disease Control, there are 40,000 reported cases of salmonella poisoning and 600 deaths annually. The CDC estimates that the actual number of salmonella cases is approximately 30 times the number of reported events. Encountering an immediate bout of illness caused by these pathogens may not be the only consequence. At least one recent report indicates that health effects associated with e-coli and other microbial pathogens may arise months or even years after the initial incident. (“Food Poisoning Legacy: Health Woes can arise Years after Bout, Doctors say,” by Lauran Neergaard reported in The Denver Post, Jan. 22, 2008.) Obviously, it is highly desirable for meat producers to deliver processed meat with minimal incidence of these bacteria.

While it is possible to promulgate regulations mandating a zero percent tolerance, i.e., incidence, for salmonella and other pathogens in products leaving a production plant, no known process exists at the present time for achieving that lofty and desirable goal. While various chemical treatments have been tried, none of them have been able to achieve a zero tolerance efficacy level for salmonella. Efforts to improve efficacy levels through the application of larger doses of chemical have been accompanied by discoloration of the meat and “off-smells” or tastes that are offensive or objectionable to potential purchasers and consumers. Many of the chemical treatments are quite expensive even at dosage levels that are not fully effective.

Accordingly, there is a significant industry and public need for improved processes that can inexpensively and effectively reduce the incidence of salmonella and other pathogens in beef and other non-poultry products leaving the production plant and that can do so without adversely affecting the color, smell or taste of the meat.

### III. SUMMARY OF THE INVENTION

It has now been found that these needs can be met by processing beef and other non-poultry meat in a meat packing plant or in post-processing with a blend of lactic acid and citric acid at appropriate conditions.

Experimental tests of the present invention have verified that it is very effective in reducing salmonella and e-coli in meat processing and post-processing. The method of the present invention does not cause discoloration of the meat or impart an off-taste or smell to the meat products. Also, it significantly reduces the presence of other pathogens in processed meat.

### IV. DETAILED DESCRIPTION OF THE INVENTION AND A PREFERRED EMBODIMENT

The present invention is particularly suited for use in the processing of beef and other non-poultry meats, e.g., pork, lamb, goats, rabbit, and other animals, at the packing plant. E-coli is the principal microbial pathogen at issue in beef slaughtering and processing facilities, but others may be implicated as well. Salmonella, for example, poses a significant risk, particularly if the meat packing plant contains an environment where fecal contamination is common. The same is true of meat packing facilities for other animals, such as pigs and lamb.

The present invention may be implemented by applying a solution of 1.0 to 2.5 wt. % citric and lactic acids to carcasses pre-chill and/or post-chill to inhibit microbial activity. (As used herein, the concentration of antimicrobial agent or ingredients therein is specified in wt./wt. %.) More specifically, the solution of citric and lactic acid may be used up to 2.5 wt. % on livestock carcasses both pre-chill and post chill and in addition may be used at these levels on offal and variety meats. The combination of citric and lactic acids may be used in the range of 1.0 to 2.5 wt. % on beef and pork primals and trimmings at 55° C. (131° F.). And the combination may be applied at 2%-2.5 wt. % to the brushes in the spray cabinets used on beef heads and tongues. The combination of citric and lactic acids may be used at any temperature. When used as a processing aid, these acids do not need to be declared as an ingredient per 21CFR 101. 100(a)(3). The use of citric and lactic acid cannot increase the carcass weight per 9CFR 441. 1O(c)(1). Both citric and lactic acid are GRAS per FDA in 21 CFR 184.106 1.

The foregoing constraints are based in part on current regulatory requirements regarding the use of lactic acid, e.g., the upper limit on concentration levels, and do not necessarily reflect effective or optimal conditions if those regulatory requirements were not in place. The blend of citric and lactic acids is not currently approved for primals and trimmings, although it is envisioned that approval will be obtained in the near future.

The combination of citric and lactic acids can be applied at many different places in the meat packing plant. One preferred point of application is immediately after carcass wash. Another preferred point of application is in the “hot box.” Some meat packing plants currently employ multiple contaminant “hurdles” (e.g., application of antimicrobial products, washing, etc.) at various points in the meat processing, and the application of citric and lactic acids could be one of those steps. In other words, application of an aqueous solution of citric and lactic acids could be the principal antimicrobial treatment or it could be employed with other processing steps.

The preferred antimicrobial agent used in the present invention comprises a blend of lactic and citric acids which are buffered by potassium hydroxide. It is likely that some potassium citrate and potassium lactate are produced as a result and may be present in the aqueous mixture as applied to the meat depending on the mixing procedure and timing. In one embodiment of the present invention, the antimicrobial agent is a mixture of citric and lactic acids sold by Purac America, Inc., Lincolnshire, Illinois, under the designation “CL 21/80.” CL21/80 contains lactic acid and lactate in an amount of approximately 43-49 wt. % and citric acid and citrate in an amount of approximately 29-35 wt. %. The product is slightly buffered with potassium hydroxide so that it provides a pH 2.0-2.2 in a 10 wt. % solution in water. Potassium is present in the product in an amount of about 1.2-1.5 wt. %. Other blends of citric and lactic acids could be employed with citric to lactic acid ratios ranging from about 1:8 to about 1:1 by weight. The preferred range of ratios is about 1:7 to about 1:3 citric acid to lactic acid.

CL 21/80 may be employed in solution in amounts ranging from about 1 wt. % to approximately 2.5 wt. %. The lower range is the minimum amount required for anti-microbial efficacy. Indeed, it has been found that at concentrations much above 2.3 wt. %, there is a tendency for the microbial treatment to result in discoloration of the meat or an off-taste or smell.

When the present invention is employed in the post-processing of meat, the preferred method of application is to spray the meat before cutting or needling. In commercial applications this can occur at a spray station as the meat passes by on a conveyor. It may also be desirable to again apply the antimicrobial after the cutting or needling operation or to apply it on the cutting blade(s) or needles (s) prior to their contacting the meat. Application may occur for approximately 1 to 60 seconds, but application times of about 1-5 seconds are preferred.

As indicated, for example, by the following tests the process of the present invention provides a significant reduction in the incidence of salmonella in harvested meat and reduces the presence of other pathogens.

### V. EXAMPLES

### Example 1

A study was performed by an independent laboratory to verify the effectiveness of using a solution of citric acid and lactic acid (i.e., Purac CL21/80) to reduce Escherichia coli 0157:H7 and Salmonella in beef. In particular, the study used USDA Select, beef tips (Beef Bottom Sirloin Butt, Tri-Tip, Boneless IMPS 185C) which were obtained directly from a commercial processing facility, i.e., a meat packing plant, and then transported to a pathogen processing facility.

Upon arrival, loins were fabricated for uniformity and inoculated with either a cocktail mixture of E. coli 0157:H7 or Salmonella (two separate inoculations) by dipping the sub-primals in a pathogen inoculated buffer solution at a 104 cfu/ml (high). A total of 5 tips/treatment/pathogen were prepared for a total of 30 tips as follows:
Five samples of non-inoculated control (NC)
Five samples of non-inoculated with treatment spray (NT)
Five samples of Escherichia coli 0157:H7 control (EC)
Five samples of Escherichia coli 0157:H7 treated (BT)
Five samples of Salmonella control (SC)
Five samples of Salmonella treated (ST)
   Inoculated tips were placed on stainless steel racks and held at refrigerated temperatures (approximately 4° C.) for one hour to facilitate “attachment.”

After the attachment period, one-half of the inoculated samples were treated with the solution of citric and lactic acids. The solution was placed into a trim sanitizing spray cabinet. The beef tips were moved along by chain at the rate of one foot per 2.5 seconds. Equipment was cleaned and sanitized between each sample and treatment combination. The antimicrobial solution was employed at a concentration of 2.5 wt. %. and at a temperature of approximately 77 deg. F. The solution was applied at a rate of about 0.66 gallons per minute for about 1.5 to 1.75 seconds. The spray cabinet had six nozzles of size 1101.5 each.

The controls and treated samples were then subjected to microbiological analysis. The external surface of each of the tips was swabbed (100 cm² area) to determine pathogen loads on the surface of the product. The swab was placed into a sterile whirl pack bag with 10 ml of peptone buffer. Appropriate dilutions and plating followed. The non-inoculated control and non-inoculated treatment were serially diluted and plated onto MAC and APC agar. The samples containing E. coli 0157:H7 were serially diluted using peptone dilution blanks and plated onto MSA with a thin-layer of TSA for cell recovery to detect total numbers remaining on the product. Samples containing Salmonella were serially diluted and plated onto XLD agar with a thin-layer of TSA for cell recovery to determine the survival of the Salmonella.

The data was then analyzed statistically using a descriptive analysis in SAS program. If a plate revealed no colonies, a count of one cfu/100 cm² was recorded in the data set for statistical program analysis purposes.

The study revealed the following results: The beef tips had an initial aerobic plate count of log 3.5 cfu/100 cm² and a generic Escherichia coli count of log 1.5 cfu/100 cm². After the beef tips were dipped into the solution of citric and lactic acids, the aerobic plate counts decreased by 1.5 logs while the generic Escherichia coli decreased by 0.4 logs. For pathogen recovery, the beef tips were inoculated to log 5.5 cfu/100 cm² with Escherichia coli 0157:H7 and Salmonella. After treatment, the Escherichia coli 0157:H7 was reduced by 1.4 logs and the Salmonella species by 1.1 logs.

### Example 2

The use of a solution of citric and lactic acids (i.e., Purac CL21/80) to reduce the incidence of e-coli and salmonella was also verified in a experimental test at a commercial slaughtering facility that normally used a solution of 5 wt. % lactic acid applied to full carcasses on the kill floor. As an alternative to the lactic acid treatment, the plant used a 2.5 wt. % solution of citric and lactic acids also applied on the kill floor during its normal production for a period of several days. Routine quality control tests were performed to detect the presence of both salmonella and e-coli on the treated meat. The results were at least as good as those normally achieved with lactic acid alone at higher concentration levels.

1. A method for reducing the incidence of salmonella and/or e-coli and other pathogens in slaughtered beef or other non-poultry meat comprising treating the meat during meat packing operations with an effective antimicrobial solution comprising citric and lactic acids.

2. The method of claim 1 in which the antimicrobial solution contains about 1 to 2.5 wt % of citric and lactic acids.

3. The method of claim 2 in which the ratio of citric acid to lactic acid in the antimicrobial solution is from about 1:8 to about 1:1 by weight.

4. The method of claim 2 in which the ratio of citric acid to lactic acid in the antimicrobial solution is from about 1:7 to about 1:3 by weight.

5. The method of claim 2 in which the ratio of citric acid to lactic acid in the antimicrobial solution is about 1:3 by weight.

6. The method of claim 3 in which the treating of the meat with the antimicrobial solution of citric and lactic acids occurs immediately after carcass wash.

7. The method of claim 4 in which the treating of the meat with the antimicrobial solution of citric and lactic acids occurs immediately after carcass wash.

8. The method of claim 3 in which the treating of the meat with the antimicrobial solution of citric and lactic acids occurs in the “hot box.”

9. The method of claim 4 in which the treating of the meat with the antimicrobial solution of citric and lactic acids occurs in the “hot box.”

10. The method of claim 3 in which the treating of the meat with the antimicrobial solution of citric and lactic acids occurs at multiple points in the meat packing process.

11. The method of claim 4 in which the treating of the meat with the antimicrobial solution of citric and lactic acids occurs at multiple points in the meat packing process.

12. The method of claim 3 in which the treating with the antimicrobial solution of citric and lactic acids occurs for about 1 to 60 seconds.

13. The method of claim 4 in which the treating with the antimicrobial solution of citric and lactic acids occurs for about 1 to 60 seconds.

14. The method of claim 3 in which the treating with the antimicrobial solution of citric and lactic acids occurs for about 1 to 5 seconds.

15. The method of claim 4 in which the treating with the antimicrobial solution of citric and lactic acids occurs for about 1 to 5 seconds.

16. In a method involving the cutting or needling of beef or other non-poultry meat the improvement comprising: reducing the incidence of salmonella and/or e-coli and other pathogens in or on the meat by treating the meat with an effective antimicrobial solution comprising citric and lactic acids.

17. The method of claim 16 in which the antimicrobial solution contains about 1 to 2.5 wt % of citric and lactic acids.

18. The method of claim 17 in which the ratio of citric acid to lactic acid in the antimicrobial solution is from about 1:8 to about 1:1 by weight.

19. The method of claim 17 in which the ratio of citric acid to lactic acid in the antimicrobial solution is about 1:7 to about 1:3 by weight.

20. The method of claim 17 in which the ratio of citric acid to lactic acid in the antimicrobial solution is about 1:3 by weight.

21. The method of claim 18 in which the treating of the meat with the antimicrobial solution of citric and lactic acids occurs by spraying the meat prior to cutting or needling.

22. The method of claim 19 in which the treating of the meat with the antimicrobial solution of citric and lactic acids occurs by spraying the meat prior to cutting or needling.

23. The method of claim 18 in which the treating of the meat with the antimicrobial solution of citric and lactic acids occurs by spraying the meat after the cutting or needling.

24. The method of claim 19 in which the treating of the meat with the antimicrobial solution of citric and lactic acids occurs by spraying the meat after the cutting or needling.

25. The method of claim 18 in which the treating of the meat with the antimicrobial solution of citric and lactic acids occurs by spraying the cutting blade or needles prior to their contacting the meat.

26. The method of claim 19 in which the treating of the meat with the antimicrobial solution of citric and lactic acids occurs by spraying the cutting blade or needles prior to their contacting the meat.

27. The method of claim 18 in which the treating of the meat with the antimicrobial solution of citric and lactic acids occurs for about 1 to 60 seconds.

28. The method of claim 19 in which the treating of the meat with the antimicrobial solution of citric and lactic acids occurs for about 1 to 60 seconds.

29. The method of claim 18 in which the treating of the meat with the antimicrobial solution of citric and lactic acids occurs for about 1 to 5 seconds.

30. The method of claim 18 in which the treating of the meat with the antimicrobial solution of citric and lactic acids occurs for about 1 to 5 seconds.

31. The method of claim 18 in which the treating occurs during the post-processing of meat.

32. The method of claim 19 in which the treating occurs during the post processing of meat.
